(19) United States
(12) Patent Application Publication
(10) Pub. No.: US 2012/0320966 A1
(43) Pub. Date: Dec. 20, 2012

(54) ADAPTIVE VIDEO DECODING CIRCUITRY AND TECHNIQUES

(75) Inventors: Shaori Guo, San Jose, CA (US); Zubing Yuan, San Jose, CA (US); Jun Ding, San Jose, CA (US)

(73) Assignee: Telegent Systems Inc. c/o M & C Corporate Services Limited, George Town (KY)

(21) Appl. No.: 13/143,047

(22) PCT Filed: Feb. 14, 2011
(86) PCT No.: PCT/US11/24695

§ 371 Date: Jun. 30, 2011

Related U.S. Application Data
(60) Provisional application No. 61/312,178, filed on Mar. 9, 2010.

(51) Int. Cl. H04N 7/32; H04N 7/26

(52) U.S. Cl. 375/240.02; 375/E07.169; 375/E07.245

(57) ABSTRACT

A method and circuitry for decoding an encoded video data stream which corresponds to a selected channel which is one of a plurality of channels of a broadcast spectrum. In one aspect, the method comprises determining one or more characteristics of the encoded video data stream, decoding the encoded video data stream to generate video data, wherein: (i) in response to determining the encoded video data stream includes a first characteristic, the encoded video data stream is decoded using a first decoding mode wherein, in response to decoding the encoded video data stream using the first decoding mode, the video data includes a first spatial resolution and a first temporal resolution, and (ii) in response to determining the encoded video data stream includes a second characteristic, the encoded video data stream is decoded using a second decoding mode wherein, in response to decoding the encoded video data stream using the second decoding mode, the video data includes a second spatial resolution and a second temporal resolution, wherein the first spatial resolution is different from the second spatial resolution and/or the first temporal resolution is different from the second temporal resolution.

### RELATED APPLICATION

This non-provisional application claims priority to U.S. Provisional Application No. 61/312,178, entitled “Adaptive Video Decoding Circuitry and Techniques”, filed Mar. 9, 2010; the contents of the U.S. Provisional Application are incorporated by reference herein, in their entirety.

### INTRODUCTION

The present inventions relate to devices and/or methods of video decoding circuitry and techniques to adaptively decode, down-sample and/or downscale video signals. More particularly, to a satellite, terrestrial and/or cable receiver (for example digital broadcasting TV receiver (for example, a mobile-type TV receiver)) implemented in an MPEG environment, in one aspect, an MPEG (or MPEG-like) decoder having circuitry and implementing techniques which adaptively decodes, down-samples and/or downscales video data. Indeed, in certain aspects, the video decoder (for example, digital) may include circuitry and/or implement techniques that facilitate or provide lower system memory constraints and/or requirements relative to conventional video decoders.

Briefly, a digital broadcast TV receiver may generally consist of a TV tuner for (i) tuning the receiver to, for example, a user selected channel of the frequency band and (ii) converting the received RF signal to a baseband signal. The digital broadcast TV receiver also includes baseband processor circuitry that responsively acquires one or more channels (associated with one or more of the user selected channels) by demodulating and decoding the baseband signal into a transport data stream. The digital broadcast TV receiver further includes circuitry to identify the selected program stream and extract and separate audio and video data streams from the transport data stream.

The digital broadcasting TV receiver also includes video and audio decoder circuitry which decompresses or decodes the corresponding audio and video data streams. Video and audio output circuitry provides video and audio rendering functions using the decompressed or decoded audio and video data streams. Finally, the digital broadcasting TV receiver generally includes a user interface (for example, a display and/or a speaker(s)) for corresponding video display and/or audio play-back.

In the context of portable devices (for example, a mobile TV), the display often supports low video resolutions, such as common interchange format (CIF) or quarter CIF (QCIF) format. When the video source has a higher resolution than that of the portable device, for example, a DVB-T TV receiver, a video downscaling operation is implemented to match or correlate the size of the decoded picture/video to the size or resolution of the display. For example, with reference to FIG. 1, after decoding, downscaling circuitry (at the output of the system memory) downscales the video data from the system memory to match the output video data to the resolution or size of the display. Here, the resolution of the reconstructed video is intended to match the video source resolution. The reconstructed video (from the picture reconstruction circuitry) is output for display and/or stored in the system memory as reference video frames for decoding subsequent video (for example, P-frames or B-frames). The output video may then be downscaled (via the down scaling circuitry) and output to a display.

### SUMMARY OF INVENTIONS

There are many inventions described and illustrated herein. The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, many of those permutations and combinations will not be discussed separately herein.

Importantly, this Summary may not be reflective of or correlate to the inventions protected by the claims in this or continuation/divisional applications hereof. Even where this Summary is reflective of or correlates to the inventions protected by the claims hereof, this Summary may not be exhaustive of the scope of the present inventions.

In a first principle aspect, certain of the present inventions are directed to circuitry and techniques of decoding an encoded video data stream which corresponds to a selected channel which is one of a plurality of channels of a broadcast spectrum. In one embodiment, the method comprises decoding the encoded video data stream, using one of a plurality of decoding modes, to generate video data, wherein:
(a) in response to determining the encoded video data stream includes a first characteristic, the encoded video data stream is decoded using a first decoding mode (for example, downscaling predictive-coded frames and/or intra-frames) wherein, in response to decoding the encoded video data stream using the first decoding mode, the video data includes a first spatial resolution and a first temporal resolution, and
(b) in response to determining the encoded video data stream includes a second characteristic, the encoded video data stream is decoded using a second decoding mode (discarding bidirectionally-predictive-coded frames) wherein, in response to decoding the encoded video data stream using the second decoding mode, the video data includes a second spatial resolution and a second temporal resolution, wherein (i) the first spatial resolution is different from the second spatial resolution and/or (ii) the first temporal resolution is different from the second temporal resolution.

The method may also including formatting the video data (using any technique now known or later developed) and outputting the formatted video data. For example, formatting the video data may include formatting the video data into formatted video data blocks by arranging the video data into one or more lines or frames which correspond to or are associated with a predetermined format and/or one or more predetermined characteristics of a video display.

In one embodiment of this aspect of the inventions, the encoded video data stream (i) is an MPEG data stream, having a GOP, and (ii) includes the first characteristic when a variable is less than a predetermined value and the second characteristic when the variable is greater than the predetermined value. Where the encoded video data stream is an MPEG data stream, in one embodiment, the variable is increased or decreased based on the number of predictive-coded frames and bidirectionally-predictive-coded frames in the GOP. In one embodiment, in response to each predictive-coded frame and bidirectionally-predictive-coded frame of the GOP, the variable is increased or decreased and the variable is compared to the predetermined value wherein when the variable is: (i) less than the predetermined value, the encoded video data stream is decoded using the first decoding mode, and (ii) greater than the predetermined value, the encoded video data stream is decoded using the second decoding mode. In addition thereto, or in lieu thereof, in response to each: (i) predictive-coded frame of the GOP, the variable is increased or decreased a first amount, and (ii) bidirectionally-predictive-coded frames of the GOP, the variable is increased or decreased a second amount. The method may further include retrieving the first and second amounts from memory.

In another embodiment, the variable is based on the size or the structure of the GOP. In this embodiment, the first spatial resolution is less than the second spatial resolution and first temporal resolution is greater than the second temporal resolution.

The method may further include decoding the encoded video data stream using a third decoding mode wherein, in response to decoding the encoded video data stream using the third decoding mode, the video data includes a third spatial resolution and/or a third temporal resolution, wherein (i) the third spatial resolution is different from the first or second spatial resolutions and/or (ii) the third temporal resolution is different from the first or second temporal resolutions. In this embodiment, the encoded video data stream may be (i) an MPEG data stream, having a GOP, and (ii) include the first characteristic when a variable is less than a first predetermined value, and the second characteristic when the variable is greater than the first predetermined value and less than a second predetermined value, and the third characteristic when the variable is greater than the second predetermined value.

In another principle aspect, the present inventions are directed to video processing circuitry to decode an encoded video data stream which corresponds to a selected channel which is one of a plurality of channels of a broadcast spectrum. The video decoder circuitry of this aspect comprises control circuitry to: (i) determine one or more characteristics of the encoded video data stream and, (ii) in response, generate control signals, including one or more first control signals and/or one or more second control signals. The video processing circuitry of this aspect of the invention also includes video decoder circuitry, coupled to the control circuitry, to: (i) decode the encoded video data stream using one of a plurality of decoding modes, including a first decoding mode and a second decoding mode, and (ii) in response, generate video data, wherein:
in response to the one or more first control signals, the decoder circuitry decodes the encoded video data stream using a first decoding mode and wherein, in response to decoding the encoded video data stream using the first decoding mode, the video decoder circuitry generates video data including a first spatial resolution and a first temporal resolution, and
in response to the one or more second control signals, the decoder circuitry decodes the encoded video data stream using a second decoding mode and wherein, in response to decoding the encoded video data stream using the second decoding mode, the video decoder circuitry generates video data including a second spatial resolution and a second temporal resolution, wherein (i) the first spatial resolution is different from the second spatial resolution and/or (ii) the first temporal resolution is different from the second temporal resolution; and

The video processing circuitry may also include output format circuitry (of any kind or type), coupled to the video decoder circuitry, to generate formatted video data using the video data.

In one embodiment, when the encoded video data stream is an MPEG data stream, having a GOP, the control circuitry generates the one or more first control signals in response to determining a variable is less than a predetermined value, and the one or more second control signals in response to determining the variable is greater than the predetermined value. Here, the first spatial resolution is less than the second spatial resolution and first temporal resolution is greater than the second temporal resolution. Moreover, the variable may be based on the size and structure of the GOP.

In another embodiment, the control circuitry calculates the variable by increasing or decreasing an initial value based on the type of predictive-coded frames in the GOP. In yet another embodiment, the control circuitry, in response to each predictive-coded frame and bidirectionally-predictive-coded frame in the GOP, increases or decreases the variable and compares the variable to the predetermined value wherein when the variable is: less than the predetermined value, the encoded video data stream is decoded using the first decoding mode, and/or greater than the predetermined value, the encoded video data stream is decoded using the second decoding mode. In this embodiment, in response to each predictive-coded frame and bidirectionally-predictive-coded frame of the GOP, the variable is increased or decreased a first amount or a second amount, respectively.

Notably, in one embodiment, when the encoded video data stream is an MPEG data stream, the first decoding mode includes downscaling predictive-coded frames and/or intra-frames. In addition thereto, or in lieu thereof, when the encoded video data stream is an MPEG data stream, the second decoding mode includes discarding bidirectionally-predictive-coded frames.

The control circuitry may also generate one or more third control signals in response to determining one or more characteristics of the encoded video data stream. In this embodiment, the video decoder circuitry, in response to the one or more third control signals, decodes the encoded video data stream using a third decoding mode and, in response to decoding the encoded video data stream using the third decoding mode, generates video data including a third spatial resolution and/or a third temporal resolution, wherein (i) the third spatial resolution is different from the first or second spatial resolutions and/or (ii) the third temporal resolution is different from the first or second temporal resolutions. Here, when the encoded video data stream is an MPEG data stream, the control circuitry generates: the one or more first control signals in response to determining a variable is less than a first predetermined value, the one or more second control signals in response to determining the variable is greater than the first predetermined value and less than a second predetermined value, and the one or more third control signals in response to determining the variable is greater than the second predetermined value.

In another embodiment, the video decoder circuitry may further include memory to store decoded video data, downscale circuitry, coupled to the memory, to downscale the decoded video data and generate downscaled decoded video data which correlates to a resolution and/or size of a predetermined video display, and selection circuitry, coupled to the memory and the downscale circuitry, to responsively output either decoded video data or downscaled decoded video data.

In another aspect, the present inventions may also be directed to a receiving device including (i) any of the video processing circuitry described and/or illustrated herein, and (ii) a video display to display the formatted video data and wherein the output format circuitry formats the video data into formatted video data by arranging the video data into one or more lines or frames.

In yet another principle aspect, the present inventions are directed to a method of simulating or testing on a computing system video processing circuitry and/or a video processing circuitry device that decodes an encoded video data stream which corresponds to a selected channel which is one of a plurality of channels of a broadcast spectrum according to any of the embodiment described and/or illustrated herein. For example, the method of simulating may comprise:
simulating application of the encoded video data stream;
simulating determination one or more characteristics of the encoded video data stream;
simulating decoding the encoded video data stream, using one of a plurality of decoding modes, to generate video data, wherein:
   in response to determining the encoded video data stream includes a first characteristic, the encoded video data stream is decoded using a first decoding mode wherein, in response to decoding the encoded video data stream using the first decoding mode, the video data includes a first spatial resolution and first temporal resolution, and
   in response to determining the encoded video data stream includes a second characteristic, the encoded video data stream is decoded using a second decoding mode wherein, in response to decoding the encoded video data stream using the second decoding mode, the video data includes a second spatial resolution and second temporal resolution;
simulating generation of formatted video data; and
simulating output of the formatted video data.

Notably, an exemplary method of testing may include a substantially similar process as described immediately above wherein testing substitutes for simulating. For the sake of brevity, such a testing process will not be repeated.

As stated herein, there are many inventions, and aspects of the inventions, described and illustrated herein. This Summary is not exhaustive of the scope of the present inventions. Indeed, this Summary may not be reflective of or correlate to the inventions protected by the claims in this or continuation/divisional applications hereof.

Moreover, this Summary is not intended to be limiting of the inventions or the claims (whether the currently presented claims or claims of a divisional/continuation application) and should not be interpreted in that manner. While certain embodiments have been described and/or outlined in this Summary, it should be understood that the present inventions are not limited to such embodiments, description and/or outline, nor are the claims limited in such a manner (which should also not be interpreted as being limited by this Summary).

Indeed, many other aspects, inventions and embodiments, which may be different from and/or similar to, the aspects, inventions and embodiments presented in this Summary, will be apparent from the description, illustrations and claims, which follow. In addition, although various features, attributes and advantages have been described in this Summary and/or are apparent in light thereof, it should be understood that such features, attributes and advantages are not required whether in one, some or all of the embodiments of the present inventions and, indeed, need not be present in any of the embodiments of the present inventions.

### BRIEF DESCRIPTION OF THE DRAWINGS

In the course of the detailed description to follow, reference will be made to the attached drawings. These drawings show different aspects of the present inventions and, where appropriate, reference numerals illustrating like structures, components, materials and/or elements in different figures are labeled similarly. It is understood that various combinations of the structures, components, and/or elements, other than those specifically shown, are contemplated and are within the scope of the present inventions.

Moreover, there are many inventions described and illustrated herein. The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, certain permutations and combinations are not discussed and/or illustrated separately herein.

FIG. 1 is a schematic block diagram representation of an MPEG-2video decoder interfacing with down scaling circuitry and a display;

FIG. 2A is a schematic block diagram representation of receiver circuitry, including video decoder circuitry, according to at least certain aspects of the present inventions;

FIG. 2B is a schematic block diagram representation of exemplary receiver circuitry for use in a digital broadcasting TV environment, including tuner circuitry, baseband processor circuitry (which may include demodulator, and/or channel decoder circuitry, and/or descrambler circuitry), transport stream de-multiplexer circuitry and video decoder circuitry, according to at least certain aspects of certain embodiments of the present inventions;

FIGS. 2C-2G are schematic block diagram illustrations of exemplary receiver circuitry and/or exemplary receiving devices, according to any of the embodiments described and/or illustrated herein, coupled to a mechanism to receive a broadcast spectrum from, for example, an electrically or optically conductive medium (for example, satellite, terrestrial and/or cable digital television environments (including, for example, digital television receiver (for example, digital broadcasting TV receiver, such as, a mobile-type TV receiver)), in conjunction with a user interface (for example, video display) and/or a recording device, according to at least certain aspects of certain embodiments of the present inventions;

FIG. 3 is a schematic block diagram representation of exemplary video decoder circuitry and control circuitry, which may be implemented in an MPEG environment or an MPEG-like environment (which is, for example, based on transmission of packets and/or frames of data), according to at least certain aspects of the present inventions;

FIG. 4 is a block diagram illustration of the size of an exemplary embodiment of the memory (which stores the decoded video data) of the video decoder relative to conventional system memory of an MPEG-2 video decoder, wherein an additional B-frame memory block is outlined in a dotted line;

FIG. 5 is a flowchart of an exemplary process of the adaptive decoding techniques, according to certain aspects of the invention, to adapt, change and/or modify the decoding, down-sampling and/or downscaling of the video data based on the size of the GOP and/or the frame structure of such GOP (for example, the number of predictive-coded frames (for example, P-frames) and bidirectionally-predictive-coded frames (for example, B-frames) in the GOP);

FIG. 6 is a portion of a flowchart of an exemplary process of the adaptive decoding techniques, according to certain aspects of the invention, to adapt, change and/or modify the decoding, down-sampling and/or downscaling of the video data based on a consecutive number of GOP having WGOP that exceed a threshold in connection with the size of the GOP and/or the frame structure of such GOP (for example, the number of predictive-coded frames (for example, P-frames) and bidirectionally-predictive-coded frames (for example, B-frames) in the GOP); notably, the portion of the flowchart illustrated in FIG. 6, together with the flowchart of the exemplary process of the adaptive decoding technique set forth in FIG. 5, excluding portion D thereof, is a flowchart of an exemplary process of the adaptive decoding techniques, according to certain aspects of the invention, to adapt, change and/or modify the decoding, down-sampling and/or downscaling of the video data based on a consecutive number of GOP having WGOP that exceed a threshold in connection with the size of the GOP and/or the frame structure of such GOP (for example, the number of predictive-coded frames (for example, P-frames) and bidirectionally-predictive-coded frames (for example, B-frames) in the GOP);

FIGS. 7A and 7B illustrate in block diagram form exemplary GOP and frames comprising such GOP of an MPEG transmission or an MPEG-like transmission, which may be implemented in conjunction with at least one embodiment of the present inventions; and

FIG. 8 is a block diagram representation of exemplary memory (for example, a register, Flash, EPROM, EEPROM, ROM, DRAM, SRAM and/or fuses) to store programmable parameters employed by the control circuitry to control the exemplary adaptive decoding techniques of the video decoder circuitry.

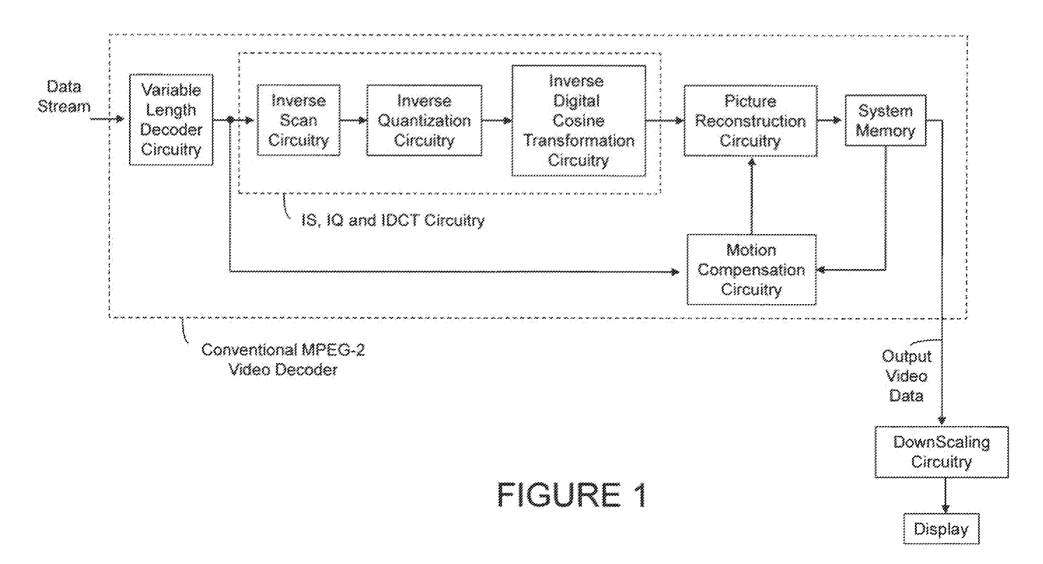

Again, there are many inventions described and illustrated herein. The present inventions are neither limited to any single aspect nor embodiment thereof, nor to any combinations and/or permutations of such aspects and/or embodiments. Each of the aspects of the present inventions, and/or embodiments thereof, may be employed alone or in combination with one or more of the other aspects of the present inventions and/or embodiments thereof. For the sake of brevity, many of those combinations and permutations are not discussed separately herein.

### DETAILED DESCRIPTION

There are many inventions described and illustrated herein. In one aspect, the present inventions are directed to circuitry and techniques for use in video decoding devices and systems that adaptively decodes, down-samples and/or downscales video signals based on the size and/or structure of the input video data streams (for example, MPEG-2 type data streams). In the context of an MPEG-n data stream, for example, the circuitry and techniques of the present inventions adaptively decode, down-sample and/or downscale video data based, at least in part on, the size of a group of pictures (GOP) and/or the structure of a GOP. In this regard, such circuitry and techniques, according to certain aspects of the invention may adapt, change and/or modify the decoding, down-sampling and/or downscaling of the video data based on the size of the GOP and/or the frame structure of such GOP (for example, the number of predictive-coded frames (P-frames) and bidirectionally-predictive-coded frames (B-frames) in the GOP, and/or the order of such frames which comprise the GOP).

Such circuitry and techniques may facilitate or provide lower system memory requirements relative to conventional video decoders. In addition to reducing memory requirements, costs and power consumption, as well as the opportunity to more readily integrate the circuitry relative to conventional video decoders, the circuitry and techniques of the present inventions may adapt, change and/or modify the temporal and/or spatial resolution of the output video to reduce error introduction, accumulation and/or propagation in the decoding, down-sampling and/or downscaling processes of the video data. Indeed, the circuitry and techniques of the present inventions may detect, determine and/or anticipate error introduction, accumulation and/or propagation in the decoding, down-sampling and/or downscaling processes of the video data, and, in response thereto, adapt, change and/or modify such processes. In this way, the circuitry and techniques of the present inventions may adapt, change and/or modify the temporal and/or spatial resolution—for example, reduce the temporal resolution and increase the spatial resolution of the output video. By doing so, the output video may be more acceptable to the user/operator regardless of or notwithstanding the characteristics of the input video data streams (for example, the size of the GOP and/or the frame structure of such GOP) and loss of resolution of the reconstructed video when correlating or matching the video source resolution to the resolution of the display.

Notably, the present inventions may be employed in a satellite, terrestrial and/or cable digital television environment (including, for example, digital television receiver (for example, digital broadcasting TV receiver, for example, mobile-type TV receiver)) and/or digital data (video and/or audio) playback devices (for example, Compact Disc (CD) or Digital Versatile Disc (DVD) player). Moreover, although many of the exemplary embodiments and/or processes are described and/or illustrated in the context of MPEG-2, the inventions described and/or illustrated herein may also be implemented in conjunction with other coded communications, for example, VC-1, Windows Media Video (WMV), RealVideo as well as other video compression/decompression standards. As such, the discussions in the context of MPEG-2 are merely exemplary; and video decoding of other coded communications, implementing one or more of the features of the present inventions as described herein, are intended to fall within the scope of the present inventions.

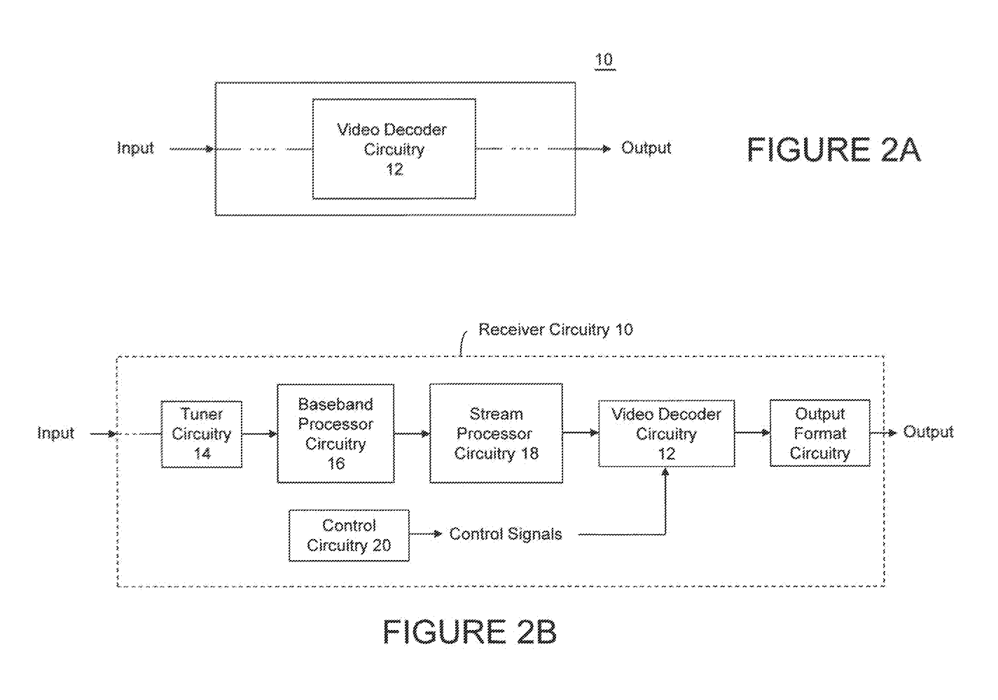

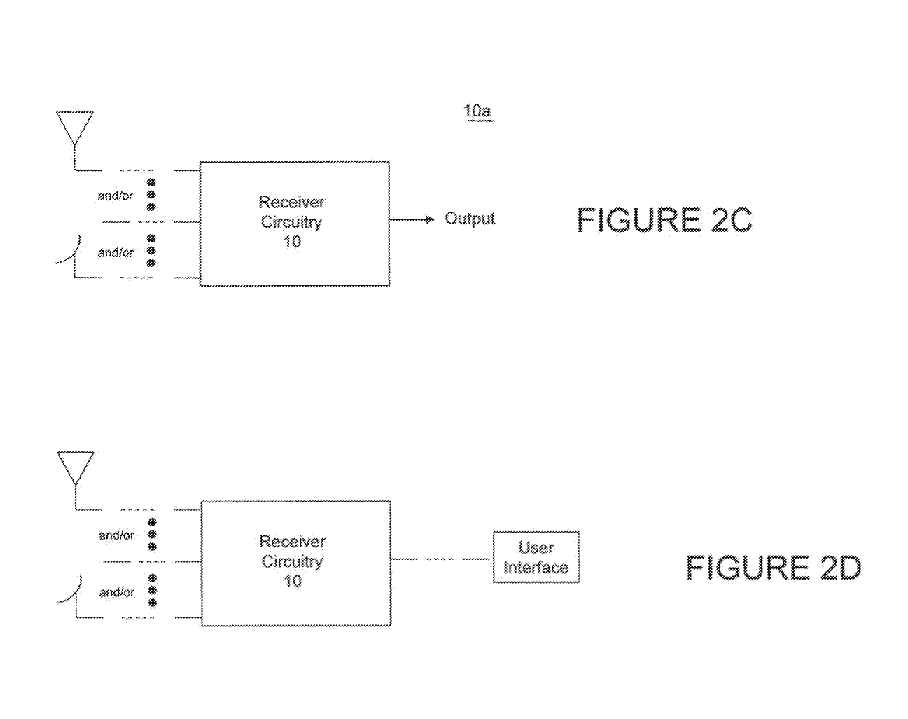

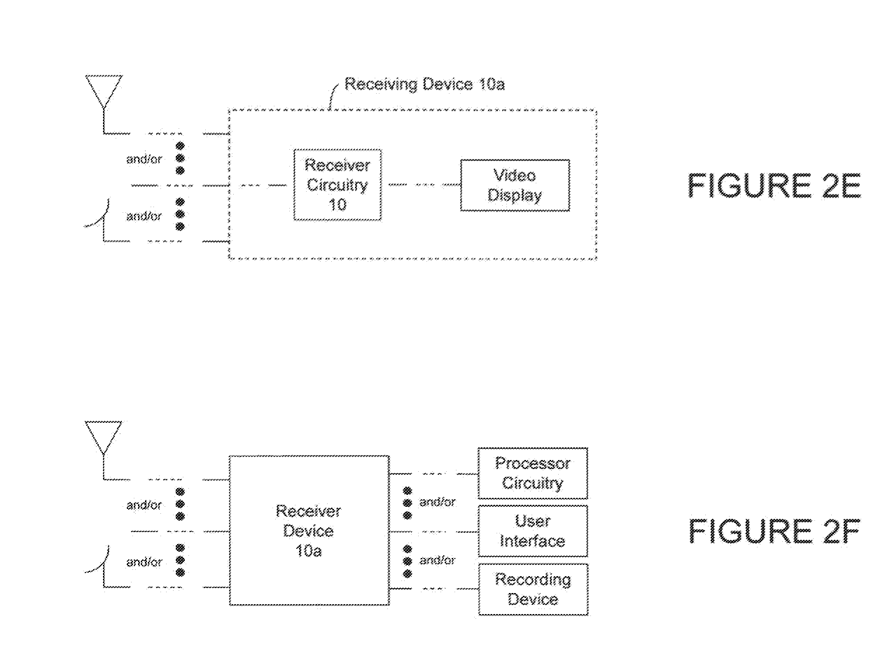

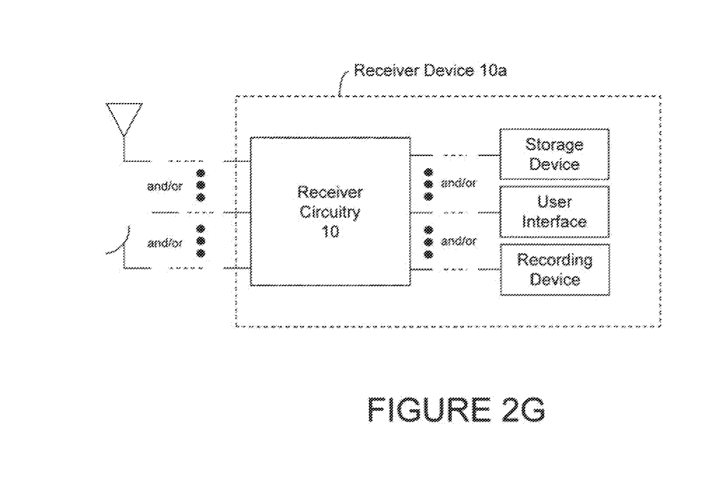

With reference to FIGS. 2A-2G, the present inventions are directed to receiver circuitry 10 having video decoder circuitry 12 to adaptively decode, down-sample and/or downscale video signals based on characteristics of the video input signals (for example, the size and/or structure of the input video data streams (for example, MPEG-2 type data streams)). The video decoder circuitry 12, in response to the characteristics of the video input signals (for example, the number of frames and/or the structure of frames of the video input signals), adapts, changes and/or modifies the decoding, down-sampling and/or downscaling of the video data. In this way, the temporal and/or spatial resolution of the output video may be modified to, for example, reduce error introduction, accumulation and/or propagation in the decoding, down-sampling and/or downscaling processes of the video data where, for example, such decoding process may be, at least partially, recursive. For example, where video decoder circuitry 12 is implemented in an MPEG-n environment (for example, MPEG-2), the video decoder circuitry may responsively adapt, change and/or modify the decoding, down-sampling and/or downscaling of the video data based on the size of the GOP and/or the frame structure of such GOP (for example, the number of predictive-coded frames (P-frames) and bidirectionally-predictive-coded frames (B-frames) in the GOP, and/or the order of such frames within the GOP).

Notably, the receiver circuitry may be incorporated into receiving device 10a. (See, for example, FIG. 2C). Moreover, the output of the receiver circuitry, receiving device and/or the video decoder circuitry may be provided to, for example, a user interface (which may include a video display), processor circuitry, a storage device and/or a recording device. (See, for example, FIGS. 2D-2G).

In one embodiment, the video decoder circuitry receives picture information (in the form of an input data stream, for example, a transport data stream) from processing circuitry (for example, transport demultiplexer circuitry) which demultiplexes a data stream which may include a header (comprising, for example, a plurality of bytes) and a payload or data load (comprising, for example, a plurality of bytes). The transport data stream may include a defined format or data hierarchy of a predefined header and a predefined payload or data load (for example, a MPEG-2 type data stream which is described in detail in/at ISO/IEC 13818). Using or based on the definition or characteristics of the transport data stream, the processing circuitry identifies the selected program stream, and extracts and separates audio and/or video data streams and provides the video data streams to video decoder circuitry. The video decoder circuitry, in response, decodes and decompresses the corresponding video data streams and video output circuitry provide video rendering functions (using the decoded and decompressed video data streams) to, for example, a user interface (for example, a display for corresponding video display play-back).

With reference to FIG. 2B, in an exemplary digital broadcasting TV receiver environment, receiver circuitry 10 may, in addition to video decoder circuitry 12 (and audio decoder circuitry, which is not illustrated), include tuner circuitry 14, baseband processor circuitry 16, stream processor circuitry 18 and output format circuitry. Briefly, tuner 14 of receiver circuitry 10 tunes to, for example, a user selected channel of the frequency band, converts a received RF signal to a baseband signal and outputs the baseband signal to baseband processor circuitry 16. The baseband processor circuitry 16 (which may include channel decoder circuitry) responsively acquires one or more channels (for example, one or more channels which are associated with one or more of the user selected channels) by demodulating and decoding the baseband signal into a transport data stream, and thereafter outputting the transport data stream to stream processor circuitry 18. The stream processor circuitry 18 demultiplexes the data stream, identifies the selected program stream, and extracts and separates audio and/or video data streams. As noted above, video decoder circuitry 12, in response, decodes and decompresses the corresponding video data streams, and video output format circuitry (not illustrated in detail) provides video rendering functions (using the decoded and decompressed video data streams) to, for example, a user interface (for example, a display) for corresponding video display play-back.

Notably, the present inventions may be implemented in conjunction with any type of tuner circuitry 14, baseband processor circuitry 16 and/or stream processor circuitry 18 (including discrete devices or integrated devices), whether now known or later developed. All tuner circuitry 14, baseband processor circuitry 16 and/or stream processor circuitry 18, consistent with digital communications outlined herein, are intended to fall within the scope of the present inventions.

Moreover, as intimated above, receiver circuitry 10 and/or receiving device 10a may also include output format circuitry to (i) format (for example, by arranging the decoded video data into one or more lines or frames) and output video data of the data block, and (ii) output display synchronization or timing signals (for example, horizontal synchronization signals, vertical synchronization signals) and/or timing markers or tags (for example, start of active video data and end of active video data) to, for example, a video display. For the sake of brevity, the output format circuitry will not be discussed in detail. It should be noted, however that any output format circuitry whether now known or later developed may be implemented in conjunction with any of the embodiments of the present inventions.

With continued reference to FIG. 2B, video decoder circuitry 12 decompresses and/or decodes the associated demodulated transport data stream. The video decoder circuitry 12 decompresses the corresponding video data streams to perform video rendering operations (using the decompressed video data streams). The video decoder circuitry 12, in response to certain characteristics of the data stream, adaptively decodes, down-samples and/or downscales video signals to, for example, accommodate, correlate and/or match the output video data to a predetermined format and/or predetermined characteristics of the video display (for the resolution of the display).

In one embodiment, the characteristics of the data stream upon which the adaption is based, are the size and/or structure of the input video data streams (for example, MPEG-2 type data streams). For example, where video decoder circuitry 12 is implemented in an MPEG-n environment (for example, MPEG-2), video decoder circuitry 12 may responsively adapt, change and/or modify the decoding, down-sampling and/or downscaling of the video data based on the size of the GOP and/or the frame structure of the GOP (for example, (i) the number of predictive-coded frames (P-frames), and/or (ii) the number of bidirectionally-predictive-coded frames (B-frames) in the GOP, and/or (iii) the order of such frames within the GOP).

The receiver circuitry 10 may also include control circuitry 20 to, among other things, detect and/or determine characteristics of the input video data stream, including, for example, the structure of the frames of the input video data stream. The control circuitry 20 may be implemented via a plurality of discrete or integrated logic, and/or one or more state machines, special or general purpose processors (suitably programmed) and/or field programmable gate arrays (or combinations thereof). Indeed, any circuitry (for example, discrete or integrated logic, state machine(s), special or general purpose processor(s) (suitably programmed) and/or field programmable gate array(s) (or combinations thereof)) to detect and/or determine characteristics of the data stream, including, for example, the size and/or structure of the input video data streams, consistent with inventions described and/or illustrated herein, is intended to fall within the scope of the present inventions.

As mentioned above, the present inventions may be employed in a satellite, terrestrial and/or cable communications environments (among others) which implements video decoder circuitry 12. (See, for example, FIGS. 2C-2G). For example, the present inventions may be implemented in a satellite, terrestrial and/or cable digital television environment and/or receiver (for example, digital broadcasting TV receiver, for example, mobile TV receiver). Moreover, receiver circuitry 10 and/or receiving device 10a may output data to a user interface (for example, display and/or speaker), processor circuitry (for example, a special purpose or general purpose processor), and/or a recording or storage device (for example, a DVD, hard drive or the like). (See, for example, FIGS. 2D-2G).

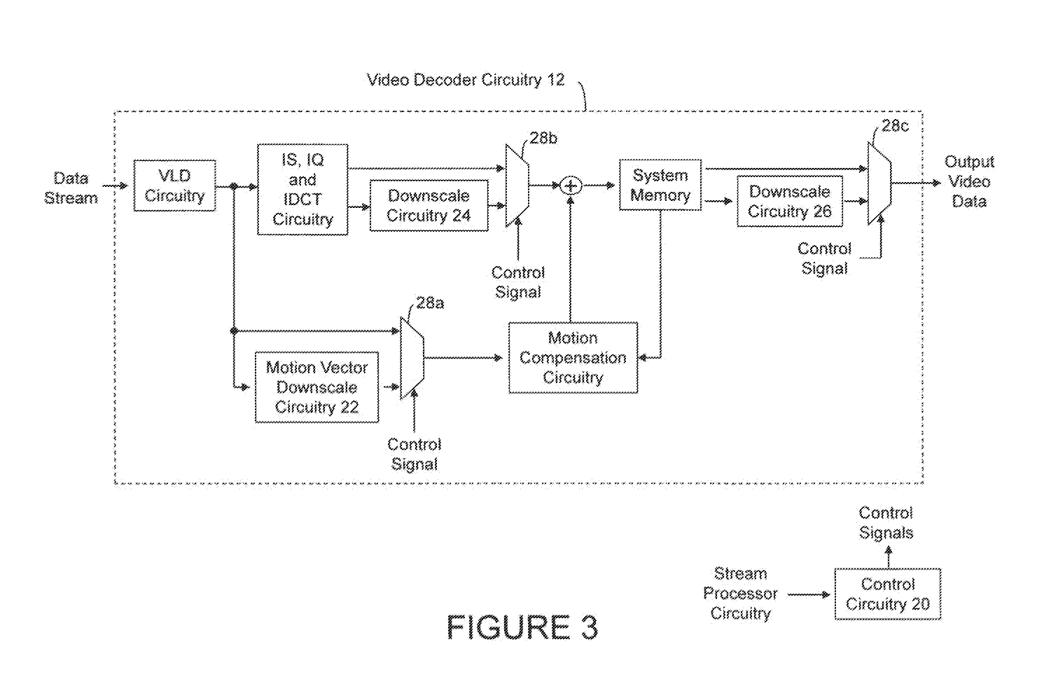

With reference to FIG. 3, in a detailed exemplary embodiment which may be employed in (i) a digital TV receiver and/or digital data (video and/or audio) playback devices (wherein the resolution of the video output is less than full resolution of the video frames embedded in the bit stream) and (ii) an MPEG-n environment (for example, MPEG-2 environment), video decoder circuitry 12 responsively adapts, changes and/or modifies the decoding, down-sampling and/or downscaling of the data based on the size of the GOP and/or the frame structure of such GOP (for example, (i) the number of predictive-coded frames (P-frames), and/or (ii) bidirectionally-predictive-coded frames (B-frames) in the GOP, and/or (ii) the order of such frames within the GOP). The video decoder circuitry 12 includes inverse scan circuitry, inverse quantization circuitry, inverse digital cosine transformation circuitry (collectively illustrated as IS, IQ and IDCT circuitry), variable length decoder circuitry and motion compensation circuitry. The IS, IQ and IDCT circuitry may be employed to at least partially recover the encoded video data. Such circuitry, and the operation thereof, is well known to those skilled in the art; and, for the sake of conciseness, will not be discussed in detail herein.

In this exemplary embodiment, video decoder circuitry 12 also includes motion vector downscale circuitry 22, downscale circuitry 24, downscale circuitry 26 and selection circuitry 28a-28c (notably, the selection circuitry illustrated herein as a multiplexer). Briefly, motion vector downscale circuitry 22, downscale circuitry 24 and downscale circuitry 26 are employed to responsively implement the adaptive decoding, down-sampling and/or downscaling processes. Such processes reduce the resolution of the video output to, for example, match or correlate the output video data, which is representative of the decoded picture/video, to a predetermined size or resolution of, for example, a video display. In this way, after decoding and downscaling the encoded video data, the output video data corresponds to or matches a predetermined resolution or size of the picture/video—which may correlate to the resolution or size of the display. The resolution of the reconstructed video—at the output of video decoder circuitry 12—may correspond or match predetermined characteristics (which may correspond or match to the resolution of the associated video display).

The video decoder circuitry 12 includes a plurality of decoding or processing modes (for example, two or more) which adapt, change and/or modify the decoding, down-sampling and/or downscaling of the data based, in this embodiment, on the size of the GOP and/or the frame structure of such GOP. With continued reference to FIG. 3, in this exemplary embodiment, video decoder circuitry 12 includes two decoding modes, namely Decode Mode 1 and Decode Mode 2. In Decode Mode 1, video decoder circuitry 12 downscales intra-frames (I-frames), predictive-coded frames (P-frames) and bidirectionally-predictive-coded frames (B-frames) to, for example, generate/output video data which corresponds to or matches a predetermined resolution or size of the picture/video (for example, which correlates or corresponds to the resolution or size of an associated video display). The predetermined resolution or size of the picture/video may be user/operator defined (for example, via an input instruction from the user interface), system defined (for example, defined by the size or resolution of an associated display) and/or geographically defined (which corresponds to the geographic region and/or the video standard (for example, NTSC, PAL, SECAM or DVB-T) in which the receiver circuitry 12 is operated).

With continued reference to FIG. 3, in one exemplary embodiment, where the video signals are interlaced-type (or the field mode), downscale circuitry 24 (i) horizontally downscales intra-frames and predictive-coded frames (for example, a 2:1 horizontal downscaling) and (ii) horizontally and vertically downscale bidirectionally-predictive-coded frames (for example, a 2:1 horizontal downscaling and 2:1 vertical downscaling). Note, in this exemplary embodiment, the intra-frames and predictive-coded frames are not vertically downscaled due to the inherent reduction in vertical resolution of interlaced-type (or the field mode) video data. In another exemplary embodiment, where the video signals are progressive or non-interlaced-type (or frame mode), downscale circuitry 24 may horizontally and vertically downscale intra-frames, predictive-coded frames and bidirectionally-predictive-coded frames (for example, a 2:1 horizontal and vertical downscaling).

Notably, downscale circuitry 24 may implement a finite impulse response low pass filter techniques to downscale the intra-frames, predictive-coded frames and bidirectionally-predictive-coded frames. Similarly, downscale circuitry 26 may also implement a finite impulse response low pass filter techniques (which may be the same as or different from techniques of downscale circuitry 24) to downscale the intra-frames and predictive-coded frames. Indeed, any technique, now known or later developed, which is consistent with downscaling operations described herein, may be employed to downscale the various frames.

With continued reference to FIG. 3, video decoder circuitry 12, when in Decode Mode 1, employs motion vector downscale circuitry 22 to coordinate the downscaling operations in connection with the motion vectors of predictive-coded frames (whether unidirectionally or bidirectionally). In this way, the video output in connection with such frames incorporates the suitable motion vector information (via the motion compensation circuitry) by locating corresponding reference block(s) from reference frame(s) to correctly downscale such predictive-coded frames when information pertaining to the frame is encoded in the motion vector. Thus, in Decode Mode 1, selection circuitry 28a and 28b responsively incorporate motion vector downscale circuitry 22 and downscale circuitry 24, respectively, into the signal path. Moreover, selection circuitry 28c responsively removes or eliminates downscale circuitry 26 from the signal path.

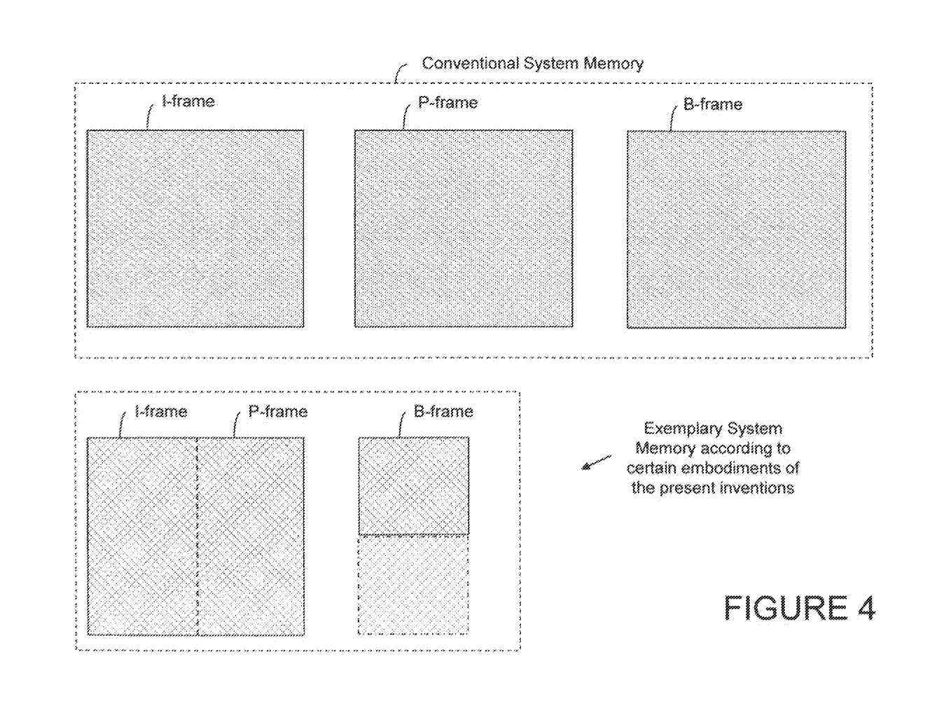

Notably, in the context of the MPEG-2 environment, downscaling circuitry 24 down-samples the 8×8 IDCT output, and motion vector downscale circuitry 22 coordinates these operations in relation to the motion vectors of predictive-coded frames and bidirectionally-predictive-coded frames. In this regard, where the video signals are interlaced-type, in Decode Mode 1, each 8×8 output array of the IDCT operation is down-sampled 2:1 in the horizontal direction, which results in a 4×8 array. The reconstructed I-frames are therefore downscaled 2:1 horizontally. As a result, a 50% of system memory reduction may be obtained or achieved for storing the decoded I-frames. (See, FIG. 4).

As for P-frames (which also includes/involves the VLD, IS IQ circuitry and the motion compensation path), motion vector downscale circuitry 22 provides 2:1 horizontal downscaling the decoded motion vector before being employed for motion compensation by motion compensation circuitry. The downscaled motion vector is subsequently used to locate the 4×8 reference blocks from the reference frame, which is already down-sampled 2:1 horizontally in the previous decoding. The reconstructed P-frame is therefore downscaled 2:1 horizontally. As such, a 50% of system memory reduction may be obtained or achieved for storing the decoded P-frames. (See, FIG. 4).

In this embodiment, the decoding of B-frames is similar to decoding P-frames except that after picture reconstruction, the 4×8 blocks are down-sampled 2:1 vertically, resulting in 4×4 blocks. The reconstructed B-frame is therefore downscaled 2:1 both horizontally and vertically. As a result, a 75% of system memory reduction may be obtained or achieved for storing the decoded B-frames. (See, FIG. 4). Notably, it may be advantageous to include additional memory block (for example, an additional ¼ block of memory) for decoding B-frames to increase speed of decoding and output as well as ease system constraints of memory use in the event that a plurality of consecutive B-frames are decoded. Such additional memory may be employed as a scratch pad and/or frame buffer during the process of decoding B-frames by video circuitry 10. (See, FIG. 4—wherein the additional B-frame memory block is illustrated via a dotted outline and different shading).

Accordingly, in this exemplary embodiment, the system memory is significantly reduced relative to the conventional system memory requirements of MPEG video decoders. Moreover, the reduction of system memory provides for a reduction of the system cost and power consumption. The system memory, according to the present inventions may facilitate or provide for more full or complete integration of the system memory into receiver circuitry 10.

Notably, the system memory may be integrated or discrete memory of any kind or type, including, for example, SRAM, DRAM, VRAM and Flash. All memory types and forms, and permutations and/or combinations thereof, are intended to fall within the scope of the present inventions. Indeed, the reduction of the system memory relative to conventional video decoders more readily allows for the implementation of the system memory in an on-chip SRAM, as opposed to an external DRAM or SRAM, both of which result in relatively more power consumption.

As mentioned above, video decoder circuitry 12 of this exemplary embodiment includes two decoding modes (i.e., Decode Mode 1 and Decode Mode 2). In Decode Mode 2, video decoder circuitry 12 discards, “drops” and/or ignores bidirectionally-predictive-coded frames (for example, B-frames in the context of MPEG) and only decodes intra-frames (I-frames) and predictive-coded frames (P-frames). In this mode, however, video decoder circuitry 12 decodes, in full-resolution, the intra-frames (I-frames) and predictive-coded frames (P-frames). The full-resolution intra-frames (I-frames) and predictive-coded frames (P-frames) are stored in system memory. After decoding, video decoder circuitry 12 may employ downscale circuitry 26 to downscale the frames, prior to output, to correlate or match the output video data to the resolution or size of the display. In this regard, downscale circuitry 26 adjusts the resolution of the output video data to match a predetermined resolution or size of the picture/video, which may correlate or correspond to the resolution or size of an associated display. Again, the predetermined resolution or size of the picture/video may be user/operator defined (for example, via an input instruction from the user interface), system defined (for example, defined by the size or resolution of an associated display) and/or geographically defined (which corresponds to the geographic region and/or the video standard (for example, NTSC, PAL, SECAM or DVB-T) in which the receiver circuitry 12 is operated).

The control circuitry 20 generates signals that control and configure the decoding, down-sampling and/or downscaling operations of video decoder circuitry 12. In one exemplary embodiment, control circuitry 20 evaluates, analyzes and/or determines the size and/or structure of the input video data streams (for example, in an MPEG-n environment, the size of the GOP, the structure of the GOP and/or the characteristics of both over a plurality of GOP(s) (for example, a plurality of consecutive GOP(s)). In response to the control signals, video decoder circuitry 12 adaptively decodes, down-samples and/or downscales the incoming video signals.

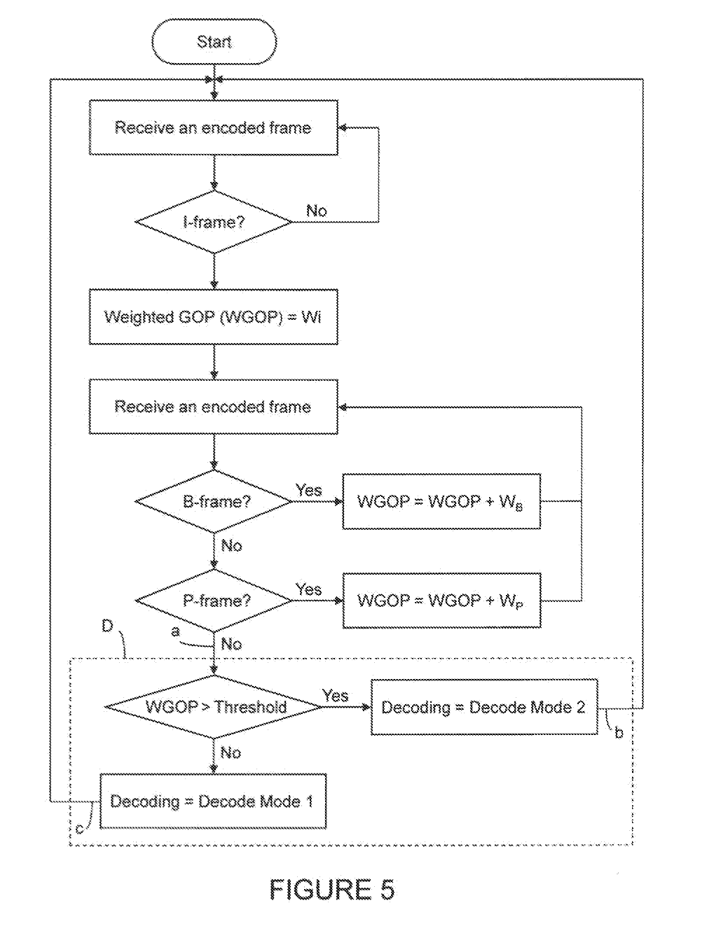

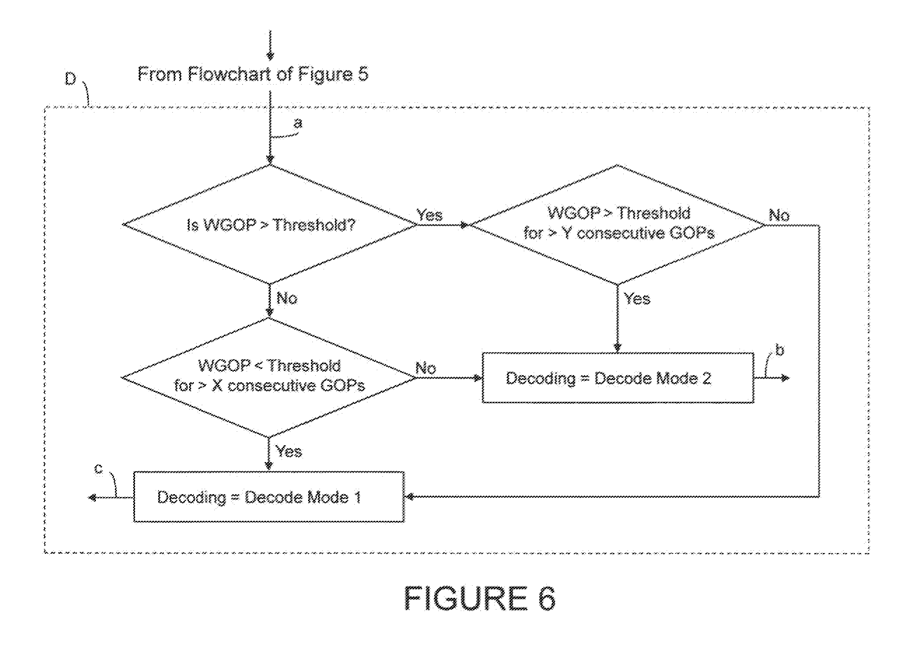

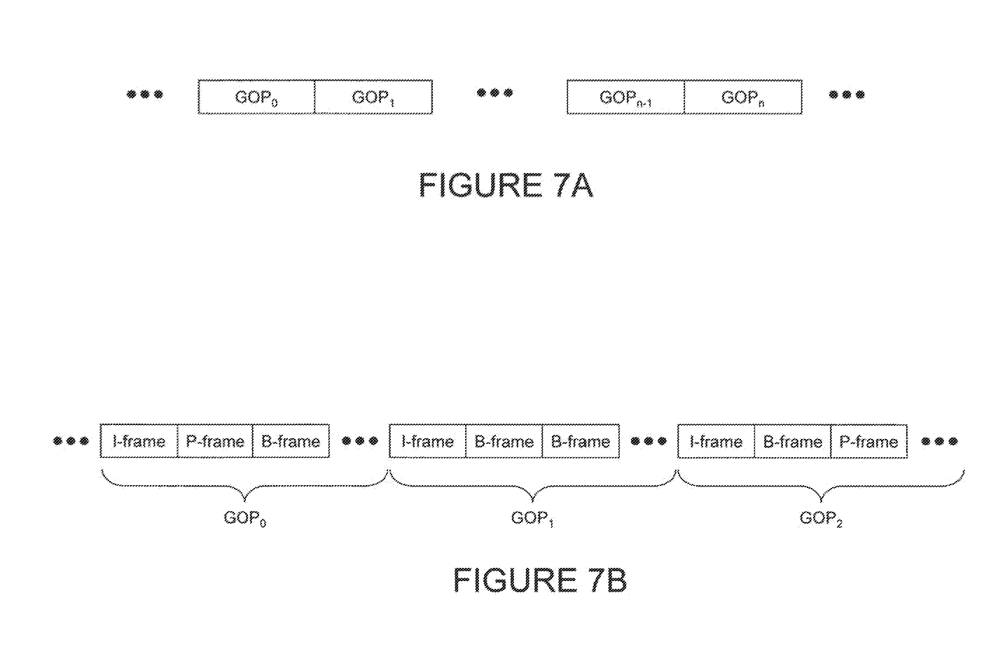

In one exemplary embodiment, control circuitry 20 may evaluate and analyze the size and structure of the input video data streams using the exemplary process illustrated in FIG. 5. In this exemplary embodiment, the incoming MPEG-n based data stream is evaluated and analyzed to determine a “weighted GOP” (WGOP) which is based on the size of the GOP and the structure of the GOP. (See, for example, FIGS. 7A and 7B).

With reference to FIGS. 5, 7A and 7B, control circuitry 20 calculates a WGOP by evaluating and analyzing the size of the GOP and the frame structure of the GOP. When the WGOP is less than a predetermined threshold, video decoder circuitry 12 is configured to decode, down-sample and/or downscale the incoming video signals according to Decode Mode 1. As discussed above, in Decode Mode 1, video decoder circuitry 12 horizontally and/or vertically downscales I-frames, P-frames and B-frames.

When the WGOP is greater than a predetermined threshold, control signals configure video decoder circuitry 12 to decode, down-sample and/or downscale the incoming video signals according to Decode Mode 2. As discussed above, in Decode Mode 2, video decoder circuitry 12 discards, “drops” and/or ignores bidirectionally-predictive-coded frames (for example, B-frames in the context of MPEG) and decodes intra-frames (I-frames) and predictive-coded frames (P-frames) with greater resolution than Decode Mode 1. Here, control circuitry 20 detects, determines and/or anticipates error introduction, accumulation and/or propagation in the decoding, down-sampling and/or downscaling processes of the video data (resulting from, for example, downscaling or down-sampling processes of the bidirectionally-predictive-coded frames (for example, B-frames in the context of MPEG) and decodes intra-frames (I-frames)). In response thereto, the control circuitry adapts, changes and/or modifies the decoding, down-sampling and/or downscaling processes by reducing the temporal resolution (via discarding the B-frames of the GOP) and increasing the spatial resolution of the output video (via decoding intra-frames (I-frames) and predictive-coded frames (P-frames) with full resolution). In this way, the output video may be more acceptable to the user/operator notwithstanding the characteristics of the transmission (for example, the size of the GOP and/or the frame structure of such GOP) and loss of resolution of the reconstructed video when correlating or matching the video source resolution to the resolution of the display.

With continued reference to FIGS. 5, 7A and 7B, in one exemplary embodiment, control circuitry 20 upon detecting an I-frame of a GOP (which is indicative of the first picture of the GOP), sets the WGOP equal to an initial value Wi. Thereafter, control circuitry 20 calculates the WGOP based on the type of frames and the number of frames in the GOP. In this regard, when control circuitry 20 determines (i) receipt of a B-frame, a value of W_{B} is added to the WGOP, and (ii) receipt of a P-frame, a value of W_{P} is added to the WGOP. Upon detecting the end of the GOP (in this embodiment, when no B-frames or P-frames are detected), control circuitry 20 determines whether the WGOP is greater than or less than a Threshold value and, in response thereto, configures video decoder circuitry 12 to decode, down-sample and/or downscale the incoming video signals according to Decode Mode 1 or Decode Mode 2.

One, some or all of the parameters employed by the decoding mode determination technique (for example, one or more of Wi, W_{B}, W_{P}, and/or Threshold) may be determined mathematically or empirically. In one exemplary embodiment and based on empirical data and subjective viewing considerations, it may be suitable to employ Wi=2, W_{B}=1, W_{P}=2 and Threshold=23.

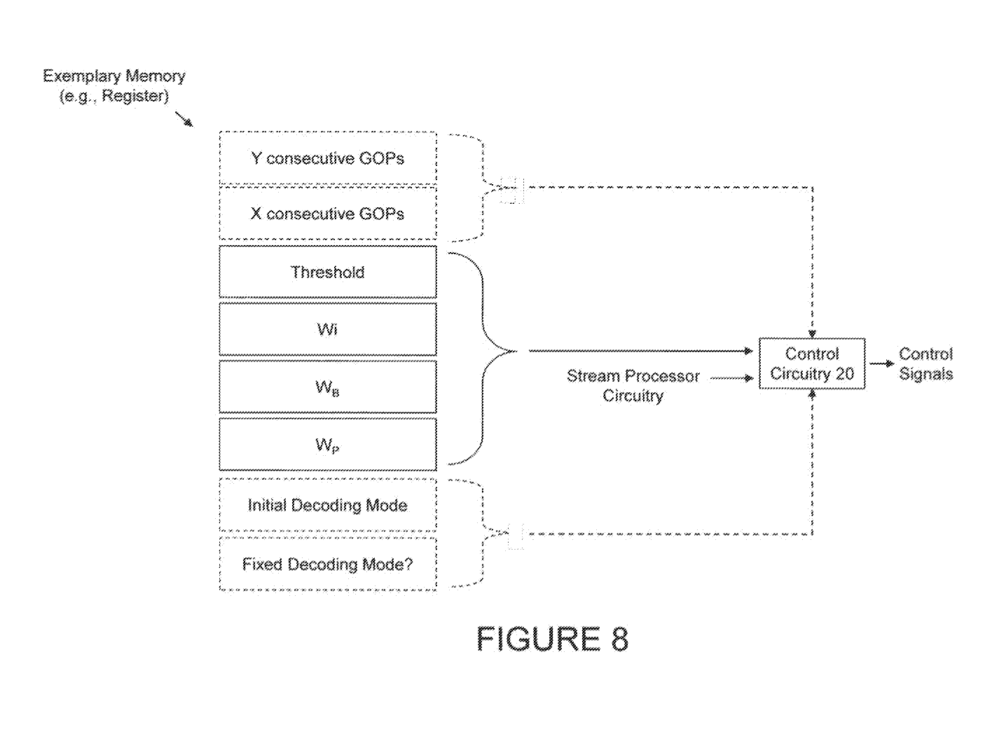

Moreover, one, some or all of the parameters employed by control circuitry 20 in the decoding mode determination technique (for example, one or more of Wi, W_{B}, W_{P}, and/or Threshold) may be fixed (for example, hardwired) or programmable (for example, one time programmable (for example, programmed during test or at manufacture) or more than one time programmable (for example, during test, start-up/power-up, during an initialization sequence and/or during operation (in situ))). Such values may be stored in memory including, for example, fuses or anti-fuses, or DRAM, SRAM, ROM, PROM, EPROM, and/or EEPROM cells, wherein data which is representative of the associated parameter may be accessible to control circuitry 20 during operation. (See, for example, FIG. 8).

In one embodiment, where the parameters (for example, one or more of Wi, W_{B}, W_{P}, and/or Threshold) are programmable, such value(s) may be updated, changed, altered and/or modified by the user and thereafter stored in memory (for example, one or more registers). In this embodiment, the information may be provided to memory and/or control circuitry, for example, at start-up/power-up, during an initialization sequence, and/or in response to a reset and/or one or more user instructions or inputs. In addition thereto, or in lieu thereof, parameters used in the decoding mode determination technique (for example, one or more of Wi, W_{B}, W_{P}, and/or Threshold) may be determined at start-up/power-up, during an initialization sequence, and/or in response to user or operator instructions based on information which is representative of the geographic region and/or the video standard (for example, NTSC, PAL, SECAM or DVB-T) in which the device is operated.

For example, it may be advantageous to change the parameters depending on the geographic region due to differences in permissible GOP sizes and/or frame format characteristics. In one exemplary embodiment, the Threshold may be modified (for example, increased) and/or one or more (or all) of Wi, W_{B}, W_{P} may be modified to accommodate the differences in the formatting and coding of the video transmission. Such information may be acquired by the user, via a broadcast (for example, by the program broadcaster) and/or determined by control circuitry 20. Indeed, different sets of parameters for the decoding mode determination technique may be stored in the memory and may be selectively accessed to closely tailor the adaptive decoding to the particular situation (for example, geographic region) in which receiver circuitry 10 and/or receiving device 10a are/is being employed. In this way, the circuitry and techniques of the present inventions, in addition to facilitating or providing lower system memory requirements relative to conventional video decoders, may adapt, change and/or modify the decoding down-sampling and/or downscaling processes of the video data (and, as such the temporal and/or spatial resolution of the output video) to the particular situation in which receiver circuitry 10 and/or receiving device 10a are/is being employed.

Notably, the memory (for example, register) which stores the parameters of the decoding mode determination technique (for example, one or more of Wi, W_{B}, W_{P}, and/or Threshold) may be a permanent, semi-permanent or temporary (i.e., until re-programmed) storage; for example, a DRAM, SRAM, ROM, PROM, EPROM, EEPROM cells that are resident on (i.e., integrated in) the control circuitry or the video decoder circuitry, or external thereto (i.e., not integrated in). All circuitry and techniques of (i) determining the value(s) Wi, W_{B}, W_{P}, and/or Threshold and (ii) programming and/or storing value(s) Wi, W_{B}, W_{P}, and/or Threshold are intended to fall within the scope of the present invention. Indeed, the memory which stores the parameters (for example, value(s) Wi, W_{B}, W_{P}, and/or Threshold) may be a portion of the system memory of video decoder circuitry 12, integrated in control circuitry 20 and/or other circuitry of receiver circuitry 10.

With the aforementioned in mind, the flowchart of FIG. 5 provides an exemplary technique for adaptively controlling the decoding, down-sampling and/or downscaling operations of video decoder circuitry 12. The control circuitry 20 “counts” the number and types of frames comprising. the GOP. Where control circuitry 20 determines the number of frames and types of frames comprising in a GOP is less than a predetermined value or threshold, control circuitry 20 enables Decode Mode 1 via control signals that configure selection circuitry 28a-c of video decoder circuitry 12. Where the number of frames and types of frames comprising in a GOP is greater than the predetermined value or threshold, control circuitry 20 enables Decode Mode 2 via control signals that configure selection circuitry 28a-c of video decoder circuitry 12. In this way, control circuitry 20 adapts, changes and/or modifies the decoding, down-sampling and/or downscaling processes of video decoder circuitry 12 based on the size of the GOP and/or the frame structure of such GOP (for example, the number of predictive-coded frames (for example, P-frames) and bidirectionally-predictive-coded frames (for example, B-frames) in the GOP)). Notably, the different configurations of video decoder circuitry 12, based on the incoming video signals, adapt, change and/or modify the temporal and/or spatial resolution of the output video to reduce error introduction, accumulation and/or propagation in the decoding, down-sampling and/or downscaling processes of the video data.

With reference to FIG. 6, in another exemplary embodiment, control circuitry 12 may evaluate and analyze the size and structure of the input video data streams to determine a “weighted GOP” which, in this embodiment, is based on the size of the GOP and the structure of the GOP over a plurality of GOP(s) (for example, a plurality of consecutive GOP(s)). The control circuitry 20, in this exemplary embodiment, determines, defines and/or controls the Decode Mode based on a plurality of consecutive GOP(s). In this regard, control circuitry 20 “counts” a number of consecutive GOP(s) having a WGOP which is greater than or less than the predetermined value or threshold. In one embodiment, where the number of consecutive plurality of GOP(s), having a WGOP which exceeds the predetermined threshold, is greater than a predetermined value, control circuitry 20 enables or maintains Decode Mode 2 via control signals which properly configure selection circuitry 28a-c of video decoder circuitry 12. Where, however, the number of consecutive plurality of GOP(s), having a WGOP which is less than the predetermined threshold, is greater than a predetermined value, control circuitry 20 enables or maintains the processing by video decoder circuitry 12 according to Decode Mode 1.

For example, where video decoder circuitry 12 is implementing Decode Mode 2 and the number of consecutive such GOP(s) (i.e., a GOP having a WGOP which do not exceed the predetermined threshold) exceeds a predetermined number, control circuitry 20 may adapt, change and/or modify the decoding, down-sampling and/or downscaling of video decoder circuitry 12 to enable Decode Mode 1 via application of control signals that properly configure selection circuitry 28a-c of video decoder circuitry 12. In this embodiment, control circuitry 20 adapts, changes and/or modifies the decoding, down-sampling and/or downscaling of video decoder circuitry 12 based on the size of the GOP and/or the frame structure of such GOP (for example, the number of predictive-coded frames (for example, P-frames) and bidirectionally-predictive-coded frames (for example, B-frames) in the GOP). In this regard, control circuitry 20 enables Decode Mode 1 via application of control signals to selection circuitry 28a-c of video decoder circuitry 12.

The discussions above in connection with the parameters employed by the decoding mode determination technique (for example, one or more of Wi, W_{B}, W_{P}, Threshold) are entirely applicable to the parameters of the decoding mode determination technique of this embodiment (which additionally include X consecutive GOPs and/or Y consecutive GOPs). For the sake of brevity, such discussions will not be repeated. Notably, in one exemplary embodiment and based on empirical data and subjective viewing considerations, it may be suitable to employ Wi=2, W_{B}=1, W_{P}=2, Threshold=23, X=3 and Y=5.

The initial or default mode of decoding, down-sampling and/or downscaling implemented by video decoder circuitry 12 may be fixed, predetermined and/or programmable. For example, control circuitry 20 may configure video decoder circuitry 12 in Decode Mode 1 upon power-up, initialization or reset. Alternatively, the user may program control circuitry 20 to configure video decoder circuitry 12 in Decode Mode 2 upon power-up or initialization, or upon the occurrence of a predetermined event. In one embodiment, upon detecting or receiving information indicative of a geographic region and/or the video standard (for example, NTSC, PAL, SECAM or DVB-T) in which the device is operated, control circuitry 20 may configure video decoder circuitry 12 in Decode Mode 2 upon power-up, initialization or reset. Indeed, the initial or default decoding, down-sampling and/or downscaling mode of operation of video decoder circuitry 12 may stored in memory and acquired during a power-up, initialization or reset operation. (See, FIG. 8).

As noted above, control circuitry 20 may be implemented using a plurality of discrete logic, a state machine, a processor or controller (for example, a microprocessor, data processor and/or video processor which is suitably programmed) and/or a field programmable gate array (or combinations thereof). Indeed, it may be advantageous to implement video decoder circuitry using a processor or controller to provide flexibility in the event that one or more modes operations are changed, updated, enhanced, modified and/or eliminated. All permutations and/or combinations of hardwired and programmable circuitry (which is programmed, for example, via software) for implementing control circuitry (and video decoder circuitry) are intended to fall within the scope of the present inventions.

Moreover, control circuitry 20 and/or video decoder circuitry 12 may include or share circuitry with other elements of a system (or components thereof) and/or perform one or more other operations, which may be separate and distinct from the mode selection determination and video decoding operations. For example, where decoder circuitry 12 is implemented via a processor (or controller), such processor or controller may implement or perform the decoding operations as described herein as well as other operations or functions which may be related to, or separate and distinct from those of decoder circuitry 12. For example, where video decoder circuitry 12 is implemented via a processor (or controller), such processor (or controller) may also be the control circuitry, stream processor circuitry and circuitry that performs other decoding operations, such as audio decoding operations.

Notably, although exemplary embodiments and/or processes have been described above, at times, in the context of MPEG-2, the inventions described and/or illustrated herein may also be implemented in conjunction with other coded communications. As such, the discussions in the context of MPEG-2 are merely exemplary.

Further, as mentioned above, receiver circuitry 10 and/or receiving device 10a may also include output format circuitry to format and output a predetermined or fixed amount of video data of the data block, output display synchronization or timing signals (for example, horizontal synchronization signals, vertical synchronization signals) and/or timing markers or tags (for example, start of active video data and end of active video data) to, for example, a video display. For the sake of brevity, the output format circuitry will not be discussed in detail. It should be noted, however that any output format circuitry whether now known or later developed may be implemented in conjunction with any of the embodiments of the present inventions. Indeed, the present inventions may be implemented in conjunction with the circuitry and techniques described and illustrated in U.S. Provisional Patent Application No. 61/361,982 (Inventors: Guo, Yuan and Ding), filed Jul. 7, 2010 and entitled “Adaptive Video Output Management and Scheduling Circuitry and Techniques”, and/or U.S. Provisional Patent Application No. 61/377,899 (Inventors: Yuan, Guo and Ding), filed Aug. 27, 2010 and entitled “Video Decoding Circuitry and Techniques for Decoding Video Frames of Different Resolutions”. The contents of these U.S. Provisional Patent Applications are incorporated herein by reference.

There are many inventions described and illustrated herein. While certain embodiments, features, attributes and advantages of the inventions have been described and illustrated, it should be understood that many others, as well as different and/or similar embodiments, features, attributes and advantages of the present inventions, are apparent from the description and illustrations. As such, the embodiments, features, attributes and advantages of the inventions described and illustrated herein are not exhaustive and it should be understood that such other, similar, as well as different, embodiments, features, attributes and advantages of the present inventions are within the scope of the present inventions.

For example, in one embodiment, the decoding, down-sampling and/or downscaling mode of operation of video decoder circuitry 12 may be defined and fixed (until re-defined or re-programmable) based on, for example, user/operator instruction (for example, via an input instruction from the user interface) and/or geographic location of operation. For example, control circuitry 20 may configure video decoder circuitry 12 in Decode Mode 1 or Decode Mode 2 regardless of in situ considerations (for example, GOP sizes and/or frame format or structure characteristics). In this embodiment, video decoder circuitry 12 employs the selected/defined decoding, down-sampling and/or downscaling mode of operation until re-defined by, for example, the user. In this way, the circuitry and techniques of the present inventions adaptively establishes a fixed operating condition of video decoder circuitry 12 (until re-programmed or re-defined) to, for example, provide a temporal and/or spatial resolution of the output video to be more acceptable to the user/operator notwithstanding the characteristics of the transmission (for example, the size of the GOP and/or the frame format or structure of such GOP) and loss of resolution of the reconstructed video when correlating or matching the video source resolution to the resolution of the display.

As noted above, the video decoder circuitry of the present inventions includes a plurality of processing/decoding modes (for example, two or more) which adapt, change and/or modify the decoding, down-sampling and/or downscaling of the data based on the characteristics of the decoded video (for example, size of the GOP and/or the frame structure of such GOP). For example, in one embodiment, the video decoder circuitry includes three decoding modes. In this embodiment, the video decoder circuitry includes, in addition to or in lieu of Decode Mode 1 and Decode Mode 2 (as discussed above), Decode Mode 3 wherein, in response to an incoming data stream having a frame or video resolution which is less than a first predetermined threshold and/or greater than a second predetermined threshold, the video decoder circuitry is configured to implement a predetermined downscaling characteristic. For example, the control circuitry may configure the video decoder circuitry to employ Decode Mode 3 when the horizontal resolution is below a predetermined horizontal resolution (for example, 360 pixels), wherein the video decoder circuitry does not perform horizontal downscaling. In addition thereto, or in lieu thereof, the video decoder circuitry may be configured to Decode Mode 3 (or Decode Mode 4) when the horizontal resolution is greater than a predetermined horizontal resolution, wherein the video decoder circuitry performs horizontal downscaling.

Thus, in these embodiments, the receiver circuitry (for example, control circuitry thereof), in response to determining the resolution or size of the incoming (decoded) picture/video is above or below a predetermined threshold, configures the video decoder circuitry to implement a predetermined downscaling operation. Notably, such resolution may be user defined (for example, via user selection of a given resolution for the broadcast), broadcast defined (for example, by the program broadcaster), and/or geographically defined (for example, a resolution which is indicative of or corresponds to a given geographic region and/or the video standard (for example, the transmission/encoding characteristics of a given region).

In another embodiment, the video decoder circuitry may include three or more decode modes based on two or more threshold values. For example, a first threshold value may be “measured” relative to the number of predictive-coded frames (P-frames) in a GOP and a second threshold may be “measured” relative to the number of predictive-coded frames (P-frames) and bidirectionally-predictive-coded frames (B-frames) in the GOP. In this regard, the control circuitry may calculate or determine a plurality of WGOPs—for example, a first WGOP based on the number of predictive-coded frames (P-frames) in a GOP and a second WGOP based on the number of predictive-coded frames (P-frames) and bidirectionally-predictive-coded frames (B-frames) in the GOP. Thus, the video decoder circuitry responsively adapts, changes and/or modifies the decoding, down-sampling and/or downscaling operations of the video data based on the plurality of WGOPs in relation to the respective thresholds. The different decode modes adapt, change and/or modify the temporal and/or spatial resolution of the output video by configuring various circuitry of the video decoder circuitry associated with and/or responsive to the decode, down-sample and/or downscale operation(s) thereof.

Importantly, the present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, many of those permutations and combinations are not discussed separately herein.

As such, the above embodiments of the present inventions are merely exemplary embodiments. They are not intended to be exhaustive or to limit the inventions to the precise circuitry, techniques, and/or configurations disclosed. Many modifications and variations are possible in light of the above teaching. It is to be understood that other embodiments may be utilized and operational changes may be made without departing from the scope of the present inventions. As such, the foregoing description of the exemplary embodiments of the inventions has been presented for the purposes of illustration and description. Many modifications and variations are possible in light of the above teaching. It is intended that the scope of the inventions not be limited solely to the description above.

As noted above, although exemplary embodiments and/or processes have been described above, at times, in the context of MPEG-2, the inventions described and/or illustrated herein may also be implemented in conjunction with other coded communications, for example, VC-1, Windows Media Video (WMV), RealVideo, as well as other video compression/decompression standards. As such, the discussions in the context of MPEG-2 are merely exemplary and the present inventions are applicable thereto.

Moreover, although exemplary embodiments and/or processes have been described above, at times, in the context of transport data streams, the inventions described and/or illustrated herein may also be implemented in conjunction with other data streams including, for example, program data streams associated with digital data (video and/or audio) playback devices (for example, CD DVD player) implementing MPEG-2 or the like formats. For the sake of brevity, the discussions above will not be repeated in connection with other data streams including, for example, program data streams; however, the inventions and embodiments thereof are fully applicable to other data streams including, for example, program data streams, which are intended to fall within the scope of the present inventions.

Notably, the various circuitry described and/or illustrated herein (or portions and/or combinations thereof) may be integrated or may be implemented using a plurality of discrete logic, whether a state machine, a special or general purpose processor (suitably programmed) and/or a field programmable gate array (or combinations thereof). All permutations and/or combinations of integrated, discrete, hardwired and programmable circuitry (which is programmed, for example, via software) for implementing the video decoder circuitry and control circuitry are intended to fall within the scope of the present inventions. For example, the baseband processor circuitry, stream processor circuitry, video decoder circuitry, control circuitry and/or output format circuitry may be integrated on a monolithic integrated circuit device.

Moreover, the circuitry of the video receiver circuitry and/or video receiving device may share circuitry with other elements of the video receiving device (or components thereof) and/or perform one or more other operations, which may be separate and distinct from that described herein. For example, the control circuitry may share circuitry with the video decoder circuitry. Indeed, such circuitry may be implemented via one or more state machines, one or more processor (suitably programmed) and/or one or more field programmable gate arrays.

It should be further noted that the various circuits and circuitry disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and HLDL, formats supporting register level description languages like RTL, and formats supporting geometry description languages such as GDSII, GDSIII, GDSIV, CIF, MEBES and any other suitable formats and languages. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.).

Indeed, when received within a computer system via one or more computer-readable media, such data and/or instruction-based expressions of the above described circuits may be processed by a processing entity (e.g., one or more processors) within the computer system in conjunction with execution of one or more other computer programs including, without limitation, net-list generation programs, place and route programs and the like, to generate a representation or image of a physical manifestation of such circuits. Such representation or image may thereafter be used in device fabrication, for example, by enabling generation of one or more masks that are used to form various components of circuits in a fabrication process.

Moreover, the various circuits and circuitry, as well as techniques, disclosed herein may be represented via simulations using computer aided design and/or testing tools. The simulation of the video receiving device, video receiver circuitry and/or video processing circuitry (or portions of the foregoing), and/or techniques implemented thereby, may be implemented by a computer system wherein characteristics and operations of such circuitry, and techniques implemented thereby, are imitated, replicated and/or predicted via a computer system. The present inventions are also directed to such simulations of the inventive video receiving device, video receiver circuitry (or portions the foregoing) and/or video processing circuitry, and/or techniques implemented thereby, and, as such, are intended to fall within the scope of the present inventions. The computer-readable media corresponding to such simulations and/or testing tools are also intended to fall within the scope of the present inventions.

Notably, in the claims, the term “circuit” means, among other things, a single component (for example, electrical/electronic) or a multiplicity of components (whether in integrated circuit form, discrete form or otherwise), which are active and/or passive, and which are coupled together to provide or perform a desired operation. The term “circuitry”, in the claims, means, among other things, a circuit (whether integrated or otherwise), a group of such circuits, one or more processors, one or more state machines, one or more processors implementing software, one or more gate arrays, programmable and/or field programmable gate arrays, or a combination of one or more circuits (whether integrated or otherwise), one or more state machines, one or more processors, one or more processors implementing software, one or more gate arrays, programmable and/or field programmable gate arrays. The term “data” means, among other things, a current or voltage signal(s) (plural or singular) whether in an analog or a digital form, which may be a single bit (or the like) or multiple bits (or the like). The term “MPEG data stream”, means any MPEG data stream, including, but not limited to MPEG-2. In addition, the term “decoding” and other forms (i.e., decoded and to decode) in the claims, means, among other things, decoding, down-sampling and downscaling and other forms thereof (for example, down-sampled and downscaled).

What is claimed is:

1. A method of decoding an encoded video data stream which corresponds to a selected channel which is one of a plurality of channels of a broadcast spectrum, the method comprising:
determining one or more characteristics of the encoded video data stream;
decoding the encoded video data stream, using one of a plurality of decoding modes, to generate video data, wherein:
in response to determining the encoded video data stream includes a first characteristic, the encoded video data stream is decoded using a first decoding mode wherein, in response to decoding the encoded video data stream using the first decoding mode, the video data includes a first spatial resolution and a first temporal resolution, and
in response to determining the encoded video data stream includes a second characteristic, the encoded video data stream is decoded using a second decoding mode wherein, in response to decoding the encoded video data stream using the second decoding mode, the video data includes a second spatial resolution and a second temporal resolution, wherein (i) the first spatial resolution is different from the second spatial resolution and/or (ii) the first temporal resolution is different from the second temporal resolution;
formatting the video data; and
outputting the formatted video data.

2. The method of claim 1 wherein the encoded video data stream (i) is an MPEG data stream, having a GOP, and (ii) includes the first characteristic when a variable is less than a predetermined value and the second characteristic when the variable is greater than the predetermined value.

3. The method of claim 2 wherein the variable is based on the size of the GOP or the structure of the GOP.

4. The method of claim 3 wherein the first spatial resolution is less than the second spatial resolution and first temporal resolution is greater than the second temporal resolution.

5. The method of claim 2 wherein the variable is increased or decreased based on the number of predictive-coded frames and bidirectionally-predictive-coded frames in the GOP.

6. The method of claim 5 wherein in response to each predictive-coded frame and bidirectionally-predictive-coded frame of the GOP, the variable is increased or decreased and the variable is compared to the predetermined value wherein when the variable is:
less than the predetermined value, the encoded video data stream is decoded using the first decoding mode, and
greater than the predetermined value, the encoded video data stream is decoded using the second decoding mode.

7. The method of claim 6 wherein in response to each:
predictive-coded frame of the GOP, the variable is increased or decreased a first amount, and
bidirectionally-predictive-coded frame of the GOP, the variable is increased or decreased a second amount.

8. The method of claim 6 further including retrieving the first and second amounts from memory.

9. The method of claim 2 wherein decoding using the first decoding mode includes downscaling predictive-coded frames and/or intra-frames.

10. The method of claim 2 wherein decoding using the second decoding mode includes discarding bidirectionally-predictive-coded frames.

11. The method of claim 2 wherein decoding using:
the first decoding mode includes downscaling predictive-coded frames and intra-frames, and
the second decoding mode includes discarding bidirectionally-predictive-coded frames.

12. The method of claim 1 wherein formatting the video data includes formatting the video data into formatted video data blocks by arranging the video data into one or more lines or frames which correspond to or are associated with a predetermined format and/or one or more predetermined characteristics of a video display.

13. The method of claim 1 further including, in response to determining the encoded video data stream includes a third characteristic, decoding the encoded video data stream using a third decoding mode wherein, in response to decoding the encoded video data stream using the third decoding mode, the video data includes a third spatial resolution and/or a third temporal resolution, wherein (i) the third spatial resolution is different from the first or second spatial resolutions and/or (ii) the third temporal resolution is different from the first or second temporal resolutions.

14. The method of claim 13 wherein the encoded video data stream (i) is an MPEG data stream, having a GOP, and (ii) includes the first characteristic when a variable is less than a first predetermined value, and the second characteristic when the variable is greater than the first predetermined value and less than a second predetermined value, and the third characteristic when the variable is greater than the second predetermined value.

15. A video processing circuitry to decode an encoded video data stream which corresponds to a selected channel which is one of a plurality of channels of a broadcast spectrum, the video decoder circuitry comprising:
control circuitry to (i) determine one or more characteristics of the encoded video data stream and, (ii) in response, generate control signals, including one or more first control signals and/or one or more second control signals;
video decoder circuitry, coupled to the control circuitry, to (i) decode the encoded video data stream using one of a plurality of decoding modes, including a first decoding mode and a second decoding mode, and (ii) in response, generate video data, wherein:
in response to the one or more first control signals, the decoder circuitry decodes the encoded video data stream using a first decoding mode and wherein, in response to decoding the encoded video data stream using the first decoding mode, the video decoder circuitry generates video data including a first spatial resolution and a first temporal resolution, and
in response to the one or more second control signals, the decoder circuitry decodes the encoded video data stream using a second decoding mode and wherein, in response to decoding the encoded video data stream using the second decoding mode, the video decoder circuitry generates video data including a second spatial resolution and a second temporal resolution, wherein (i) the first spatial resolution is different from the second spatial resolution and/or (ii) the first temporal resolution is different from the second temporal resolution; and
output format circuitry, coupled to the video decoder circuitry, to generate formatted video data using the video data.

16. The video processing circuitry of claim 15 wherein the encoded video data stream is an MPEG data stream, having a GOP, and wherein the control circuitry generates:
the one or more first control signals in response to determining a variable is less than a predetermined value, and
the one or more second control signals in response to determining the variable is greater than the predetermined value.

17. The video processing circuitry of claim 16 wherein the first spatial resolution is less than the second spatial resolution and first temporal resolution is greater than the second temporal resolution.

18. The video processing circuitry of claim 16 wherein the variable is based on the size of the GOP and structure of the GOP.

19. The video processing circuitry of claim 16 wherein the control circuitry calculates the variable by increasing or decreasing an initial value based on the type of predictive-coded frames in the GOP.

20. The video processing circuitry of claim 16 wherein the control circuitry, in response to each predictive-coded frame and bidirectionally-predictive-coded frame in the GOP, increases or decreases the variable and compares the variable to the predetermined value wherein when the variable is:
less than the predetermined value, the encoded video data stream is decoded using the first decoding mode, and/or
greater than the predetermined value, the encoded video data stream is decoded using the second decoding mode.

21. The video processing circuitry of claim 20 wherein in response to each:
predictive-coded frame of the GOP, the variable is increased or decreased a first amount, and/or
bidirectionally-predictive-coded frame of the GOP, the variable is increased or decreased a second amount.

22. The video processing circuitry of claim 15 wherein the encoded video data stream is an MPEG data stream and wherein the first decoding mode includes downscaling predictive-coded frames and/or intra-frames.

23. The video processing circuitry of claim 15 wherein the encoded video data stream is an MPEG data stream and wherein the second decoding mode includes discarding bidirectionally-predictive-coded frames.

24. The video processing circuitry of claim 15 wherein the encoded video data stream is an MPEG data stream and wherein:
the first decoding mode includes downscaling both types of predictive-coded frames and/or intra-frames, and
the second decoding mode includes discarding bidirectionally-predictive-coded frames.

25. The video processing circuitry of claim 15 wherein:
the control circuitry generates one or more third control signals in response to determining one or more characteristics of the encoded video data stream; and
the video decoder circuitry, in response to the one or more third control signals, decodes the encoded video data stream using a third decoding mode and, in response to decoding the encoded video data stream using the third decoding mode, generates video data including a third spatial resolution and/or a third temporal resolution, wherein (i) the third spatial resolution is different from the first or second spatial resolutions and/or (ii) the third temporal resolution is different from the first or second temporal resolutions.

26. The video processing circuitry of claim 25 wherein the encoded video data stream is an MPEG data stream, having a GOP, and wherein the control circuitry generates:
the one or more first control signals in response to determining a variable is less than a first predetermined value,
the one or more second control signals in response to determining the variable is greater than the first predetermined value and less than a second predetermined value, and
the one or more third control signals in response to determining the variable is greater than the second predetermined value.

27. The video processing circuitry of claim 15 wherein the video decoder circuitry includes:
memory to store decoded video data;
downscale circuitry, coupled to the memory, to downscale the decoded video data and generate downscaled decoded video data which correlates to a resolution and/or size of a predetermined video display; and
selection circuitry, coupled to the memory and the downscale circuitry, to responsively output either the decoded video data or the downscaled decoded video data.

28. A receiving device comprising the video processing circuitry of claim 15 wherein the receiving device further includes a video display to display the formatted video data and wherein the output format circuitry formats the video data into formatted video data by arranging the video data into one or more lines or frames.

29. A method of simulating on a computing system video processing circuitry which decodes an encoded video data stream which corresponds to a selected channel which is one of a plurality of channels of a broadcast spectrum, the method comprising:
simulating application of the encoded video data stream;
simulating determination one or more characteristics of the encoded video data stream;
simulating decoding the encoded video data stream, using one of a plurality of decoding modes, to generate video data, wherein:
in response to determining the encoded video data stream includes a first characteristic, the encoded video data stream is decoded using a first decoding mode wherein, in response to decoding the encoded video data stream using the first decoding mode, the video data includes a first spatial resolution and first temporal resolution, and
in response to determining the encoded video data stream includes a second characteristic, the encoded video data stream is decoded using a second decoding mode wherein, in response to decoding the encoded video data stream using the second decoding mode, the video data includes a second spatial resolution and second temporal resolution;
simulating generation of formatted video data; and
simulating output of the formatted video data.
